(19) United States
(12) Patent Application Publication
(10) Pub. No.: US 2012/0293590 A1
(43) Pub. Date: Nov. 22, 2012

(54) LIQUID CONTAINER AND LIQUID EJECTING APPARATUS INCLUDING LIQUID CONTAINER

(75) Inventors: Junpei Yoshida, Matsumoto-shi (JP); Yuichi Nishihara, Matsumoto-shi (JP)

(73) Assignee: Seiko Epson Corporation, Shinjuku-ku (JP)

(21) Appl. No.: 13/476,734

(22) Filed: May 21, 2012

(30) Foreign Application Priority Data
May 20, 2011 (JP) 2011-113197

(51) Int. Cl. B41J 2/175

(52) U.S. Cl. 347/86

(57) ABSTRACT

A liquid chamber for a liquid ejecting apparatus includes a prism disposed on a bottom portion of the liquid chamber. The prism includes a first reflection surface having a first reflection region by which light incident on the prism from a light emitting element is reflected when liquid does not make contact with the first reflecting region. The prism includes a relief that includes a first relief surface opposed to the first reflection region. The thickness of the prism between the first reflection region and the first relief surface is substantially constant. The constant thickness of the prism between the first reflection region and the first relief surface suppresses deflection of the first reflection region, thereby improving sensitivity for the detection of liquid in the liquid chamber.

This application claims priority to Japanese Application No. 2011-113197, filed May 20, 2011, the entirety of which is incorporated by reference herein.

### BACKGROUND

1. Technical Field

The present invention relates to a liquid container configured for attachment to a liquid ejecting apparatus.

2. Related Art

An ink jet printer is an example of a known liquid ejecting apparatus that ejects liquid such as ink from an ejecting head. The liquid to be ejected from the ejecting head is accommodated in a dedicated liquid container such as an ink cartridge and the liquid is supplied from the liquid container to the ejecting head. Such liquid containers are generally configured to be detachably attached to the liquid ejecting apparatus so as to be exchanged for a new liquid container if liquid therein runs out.

In such a liquid ejecting apparatus, if an ejection operation is performed in a state where liquid in the liquid container runs out and liquid is not supplied to the ejecting head, an idling ejection occurs that may damage the ejecting head. In order to prevent such damage, there has been proposed a technique of optically detecting liquid in a liquid container by using a rectangular prism provided on a bottom portion in the liquid container, and a light emitting element and a light receiving element that are provided on a main body of a liquid ejecting apparatus (for example, JP-A-2000-71471). If a sufficient amount of the liquid is left in the liquid container and the liquid is in contact with two reflection surfaces (first reflection surface and second reflection surface) of the prism, light from the light emitting element provided at the lower side in the vertical direction is not reflected by the first reflection surface and transmits through the liquid container. On the other hand, if the liquid in the liquid container is consumed, the first reflection surface and the second reflection surface of the prism are exposed from the liquid and are in contact with the air, the light from the light emitting element reaches the light receiving element, which is arranged in parallel with the light emitting element. At this time, the light from the light emitting element reaches the light receiving element through a predetermined reflected light path on which the light is reflected by the first reflection surface in the horizontal direction and is further reflected by the second reflection surface to the lower side in the vertical direction. Accordingly, presence/absence of the liquid in the liquid container can be detected depending on whether the light receiving element receives the light from the light emitting element.

Further, when the prism is formed by injection molding of a plastic material, so-called sink marks are generated due to contraction when the plastic material is solidified and the reflection surfaces of the prism are warped in some cases. If the reflection surfaces of the prism are warped, the light from the light emitting element becomes scattered and fails to reach the light receiving element, resulting in decreased liquid detection sensitivity. In an effort to suppress formation of the sink marks, a recess called “relief” can be provided on a bottom surface of the prism (for example, JP-A-2000-127432). The relief of the prism is provided so as not to obstruct the above-mentioned reflected light path in the prism on which the light from the light emitting element is made to reach the light receiving element. Moreover, the relief is preferably as large as possible in order to maximize suppression of the sink marks. Therefore, the relief has been formed into such a shape that a cross section obtained by cutting the prism along a plane including the reflected light path is a quadrangular shape.

However, in the prism on which the relief is provided, there has arisen a problem in that detection sensitivity for liquid in the liquid container is not improved and is rather lowered in spite of the presence of the relief. That is to say, if the relief is formed to have a quadrangular cross-sectional shape in order to make the relief larger, corner portions of the relief are closer to regions (reflection regions) on the reflection surfaces of the prism by which light is actually reflected and a thickness of the prism is locally reduced near the corner portions of the relief. Therefore, the degree of the sink marks varies substantially around the corner portions of the relief so as to generate deformation of the reflection surfaces. As a result, although the sink marks (surface deformation) are suppressed on the reflection surfaces of the prism as a whole, the deformation of the reflection regions by which light is actually reflected is increased. This results in lowering the detection sensitivity for liquid in the liquid container in some case.

### SUMMARY

A technique of improving sensitivity for detecting liquid in a liquid container of a liquid ejecting apparatus is disclosed. The liquid container includes a liquid chamber and a prism having a relief that is configured to suppress deformation of reflection surfaces of the prism. Light emitted from a light emitting element is reflected by the prism such that a determination can be made as to whether the liquid in the liquid chamber exceeds a certain level. By suppressing deformation of the reflection surfaces of the prism, improved detection sensitivity can be achieved. Such deformation suppression is particularly beneficial when the prism is formed by resin molding.

Thus, in one aspect, a liquid container is disclosed that is configured to be detachably attached to a liquid ejecting apparatus that includes an optical sensor. The optical sensor includes a light emitting element and a light receiving element. The liquid container includes a liquid chamber and a prism. The liquid chamber accommodates liquid to be ejected from the liquid ejecting apparatus. The prism is disposed on a bottom portion of the liquid chamber. The prism includes a first reflection surface having a first reflection region by which light incident on the prism from the light emitting element is reflected when the liquid does not make contact with the first reflection surface. The thickness of the prism between the first reflection region and the first relief surface is substantially constant.

In the liquid container, the prism, which includes the first reflection surface, is provided on the bottom portion of the liquid accommodation chamber. If the liquid container is attached to the liquid ejecting apparatus, which includes the optical sensor, light from the light emitting element is incident on the prism. If liquid does not make contact with the first reflection region of the first reflection surface, the light incident on the prism from the light emitting element is reflected by the first reflection region toward the light receiving element. Therefore, depletion of the liquid in the liquid container (the amount of liquid becomes smaller than a predetermined amount) can be detected based on reception of light by the light receiving element.

As described above, on a prism having a relief, if the relief is configured such that the thickness of the prism between the first reflection region and the first relief surface is not substantially constant, the extent to which the first reflection region is deformed may be increased due to increased degree of associated sink marks. In order to suppress deformation of the first reflection region, the first relief surface is provided such that the thickness of the prism between the first reflection region and the first relief surface is substantially constant. As a result, the light emitted from the light emitting element is reflected by the first reflection region in an appropriate directions so as to reach the light receiving element. This makes it possible to improve detection sensitivity for the liquid in the liquid container.

In the liquid container, it is preferable that the first opposing surface be provided to have a width equivalent to the first reflection region. For example, as for the first relief surface, when perpendicular lines with respect to the first reflection surface are drawn from points on a contour of the first reflection region, a width of a shape formed by connecting intersections between the perpendicular lines and the first relief surface can be made to be a width equivalent to the first reflection region. In this case, when the first reflection region and the first relief surface are parallel with each other, the width of the first reflection region and the width of the first relief surface are equal to each other. However, when the first reflection region and the first relief surface are not parallel with each other, the width of the first relief surface becomes different from the width of the first reflection region depending on an angle of the first relief surface.

In the liquid container, it is preferable that the relief be formed into a shape so as not to overlap (intersect) with any of a light path between the light emitting element and the first reflection region, and a light path between the first reflection region and the light receiving element.

With this configuration, light emitted from the light emitting element is not obstructed by the relief along the light path between the light emitting element and the light receiving element. Therefore, loss of light which reaches the light receiving element can be suppressed. In addition, if a size of the relief is configured to be as large as possible without overlapping with the reflected light path, deformation of the first reflection surface can be effectively suppressed.

Further, in the liquid container it is preferable that the first relief surface) be parallel to the first reflection region.

Even if the first relief surface is not necessarily parallel with the first reflection region, the thickness of the prism between the first reflection region and the first relief surface can be configured to be substantially constant. Therefore, even in such a case, ??????deformation of the first reflection region is suppressed. Further, in particular, if the first relief surface is provided in parallel with the first reflection region, the thickness of the portion of the prism between the first reflection region and the first relief surface can be made constant, thereby making the degree of sink marks uniform on the first reflection region and the second reflection region. As a result, deformation of the first reflection region can be further suppressed.

In many embodiments, the prism is formed by resin molding. Because a prism formed by resin molding may tend to form deformed surfaces due to sink marks, the reliefs disclosed herein may be particularly beneficial in suppressing surface deformation of reflecting surfaces of such resin molded prisms.

In many embodiments, the relief is formed into a shape so as to not overlap with any of a light path between the light emitting element and the first reflection region, and a light path between the first reflection region and the light receiving element.

In many embodiments, the first relief surface is a plane offset from the first reflection region. In many embodiments, the first relief surface is a plane parallel to the first reflection region.

In many embodiments, the prism further includes a second reflection surface having a second reflection region by which light reflected by the first reflection region is reflected toward the light receiving element when the liquid does not make contact with the second reflection region. The relief can further include a second relief surface opposed to the second reflection region. The thickness of the prism between the second reflection region and the second relief surface is substantially constant. In many embodiments, the relief is formed into a shape so as to not overlap with any of a light path between the light emitting element and the first reflection region, a light path between the first reflection region and the second reflection region, and a light path between the second reflection region and the light receiving element. In many embodiments, the first relief surface is a plane offset from the first reflection region and the second relief surface is a plane offset from the second reflection region. In many embodiments, the first relief surface is a plane parallel to the first reflection region and the second relief surface is a plane parallel to the second reflection region.

In another aspect, liquid ejecting apparatus are disclosed that include a liquid container as disclosed herein. A liquid ejecting apparatus can include any of the liquid containers as disclosed herein.

In many embodiments, the liquid ejecting apparatus includes an optical sensor. The optical sensor includes a light emitting element and a light receiving element. In many embodiments, the liquid ejecting apparatus includes a prism disposed on a bottom portion of an attached liquid container. In many embodiments, the first relief surface opposed to the first reflection region on the first reflection surface and the second relief surface opposed to the second reflection region on the second reflection surface are provided on the relief formed on the prism. With this, the thickness of the prism between the first reflection region and the first relief surface is substantially constant. Likewise, the thickness of the prism between the second reflection region and the second relief surface is substantially constant. As a result, the light irradiated from the light emitting element is reflected by the first reflection region and the second reflection region in appropriate directions so as to reach the light receiving element. This makes it possible to improve detection accuracy for liquid in the liquid container.

### BRIEF DESCRIPTION OF THE DRAWINGS

The invention will be described with reference to the accompanying drawings, wherein like numbers reference like elements.

FIG. 1 schematically illustrates an ink jet printer to which ink cartridges are attached as an example of a liquid ejecting apparatus, in accordance with many embodiments.

FIG. 2 schematically illustrates ink cartridge, in accordance with many embodiments.

FIGS. 3A and 3B are descriptive views illustrating a shape of a prism included in an ink cartridge, in accordance with many embodiments.

FIGS. 4A and 4B are descriptive views illustrating a state where presence/absence of ink in the ink cartridge is detected by using the prism, in accordance with many embodiments.

FIGS. 5A and 5B are descriptive views for explaining a reason why a relief is provided on the prism and illustrating an existing prism having a relief.

FIGS. 6A and 6B are descriptive views for explaining a reason why detection sensitivity for ink in the ink cartridge is deteriorated with the existing prism having the relief.

FIG. 7 is a descriptive view illustrating a shape of a relief formed on a prism of an ink cartridge, in accordance with many embodiments.

FIGS. 8A and 8B are descriptive views for explaining a reason why detection sensitivity for ink in an ink cartridge is improved by providing opposing surfaces on a relief, in accordance with many embodiments.

FIG. 9 is a descriptive view illustrating a case where the opposing surfaces of a relief are not parallel with a first reflection region and a second reflection region respectively, in accordance with many embodiments.

FIG. 10 is a cross-sectional view illustrating a prism having a relief of which the cross-sectional shape is pentagonal, in accordance with many embodiments.

FIG. 11 is a cross-sectional view illustrating a prism having a relief of which the cross-sectional shape is triangular, in accordance with many embodiments.

### DESCRIPTION OF EXEMPLARY EMBODIMENTS

Hereinafter, an embodiment of the invention is described in accordance with the following order in order to clarify contents of the invention as described above.

### Configuration of Ink Jet Printer

### Configuration of Ink Cartridge

### Ink Detection Method

### Variations

### First Variation

### Second Variation

### Configuration of Ink Jet Printer

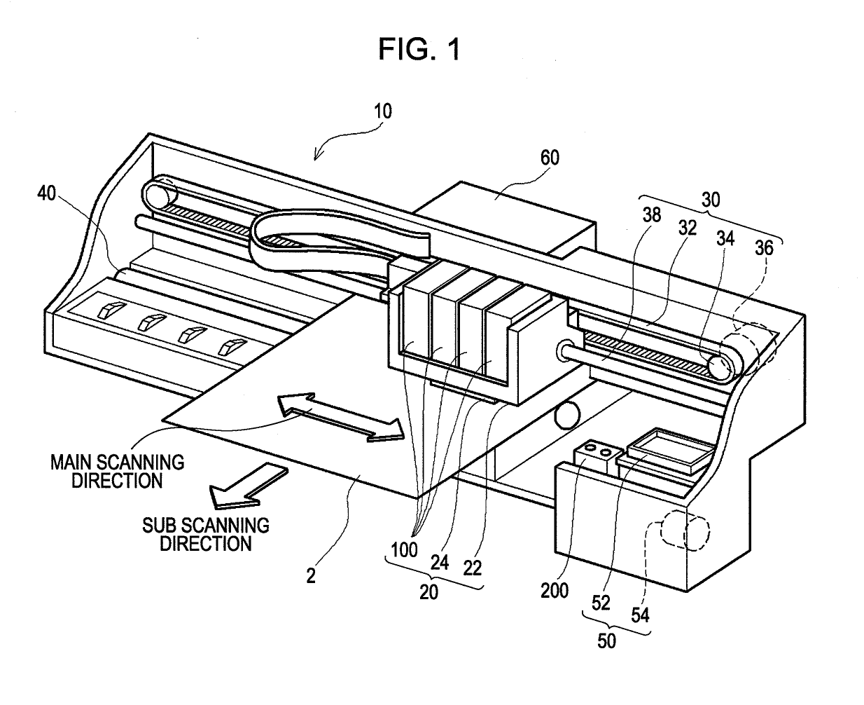

FIG. 1 is a descriptive view illustrating a schematic configuration of a liquid ejecting apparatus by taking an ink jet printer to which ink cartridges are attached as an example. As illustrated in FIG. 1, an ink jet printer 10 is constituted by a carriage 20, a driving mechanism 30, a platen roller 40, a maintenance mechanism 50, and the like. The carriage 20 forms ink dots on a print paper 2 as a print medium while reciprocating in a main scanning direction. The driving mechanism 30 makes the carriage 20 reciprocate. The platen roller 40 is a roller for feeding the print paper 2. The maintenance mechanism 50 performs maintenance such that printing can be performed normally. Ink cartridges 100, a carriage case 22, an ejecting head 24, and the like are provided on the carriage 20. The ink cartridges 100 accommodate inks. The ink cartridges 100 are attached to the carriage case 22. The ejecting head 24 is mounted on the carriage case 22 at a bottom surface side (side opposed to the print paper 2). A plurality of ejection nozzles for ejecting ink are formed in the ejecting head 24. Each ink in the ink cartridges 100 is supplied to the ejecting head 24 and an accurate amount of ink is ejected through the ejection nozzle onto the print paper 2 so that an image or the like is printed.

In the ink jet printer 10 according to the embodiment, a color image can be printed by using four types of inks including cyan, magenta, yellow, and black. In response thereto, the ejection nozzles are provided in the ejecting head 24 mounted on the carriage 20 for each type of ink. Further, the ink cartridge 100 is also provided for each type of ink. Inks are supplied to the respective ejection nozzles from the ink cartridges 100 for corresponding colors. In addition, the ink cartridges 100 are configured to be detachably attached to the carriage case 22 such that the ink cartridges 100 can be exchanged for new ink cartridges 100 if inks therein run out. It is to be noted that the ink cartridge 100 in the embodiment corresponds to a “liquid container” according to the invention.

The driving mechanism 30 which makes the carriage 20 reciprocate is constituted by a guide rail 38, a timing belt 32, a driving pulley 34, a step motor 36, and the like. The guide rail 38 is provided to extend in the main scanning direction. A plurality of tooth marks are formed on the timing belt 32 at the inner side. The driving pulley 34 engages with the tooth marks of the timing belt 32. The step motor 36 is a motor for driving the driving pulley 34. A part of the timing belt 32 is fixed to the carriage case 22. If the timing belt 32 is driven, the carriage case 22 is moved along the guide rail 38.

The platen roller 40 which feeds the print paper 2 is driven by a driving motor and a gear mechanism (not illustrated) so as to feed the print paper 2 in a sub scanning direction by a predetermined amount for each time.

The maintenance mechanism 50 is provided on a region called home position on the outside of a print region. The maintenance mechanism 50 is constituted by a cap 52, a suction pump 54, and the like. The suction pump 54 is provided at a lower position with respect to the cap 52. The cap 52 can be moved in an up-down direction by an elevating mechanism (not illustrated). The carriage 20 is moved to the home position and the cap 52 is moved up while the ink jet printer 10 does not print an image or the like. Then, the cap 52 is pressed against a bottom surface side of the ejecting head 24 so that a closed space is formed so as to cover the ejection nozzles, thereby suppressing ink in the ejecting head 24 from drying. Further, the suction pump 54 is connected to the cap 52 through a suction tube (not illustrated). If the suction pump 54 is operated in a state where the cap 52 is pressed against the bottom surface side of the ejecting head 24, the suction pump 54 executes an operation (so-called cleaning) of sucking deteriorated ink (ink which is dried and increased in viscosity) in the ejecting head 24.

Further, a sensor 200 for optically detecting presence/absence of inks in the ink cartridges 100 is provided at the home position so as to be adjacent to the cap 52 at the print region side. As will be described in detail later, a light emitting element and a light receiving element are arranged in parallel in the sensor 200. Light is emitted from the light emitting element when the ink cartridges 100 pass through a position above the sensor 200 with the movement of the carriage 20 so as to detect presence/absence of inks in the ink cartridges 100 based on reception of the light by the light receiving element.

In addition, a controller 60 which controls the overall operations of the ink jet printer 10 is mounted on a rear surface side of the ink jet printer 10. The controller 60 controls all of an operation of making the carriage 20 reciprocate, an operation of feeding the print paper 2, an operation of ejecting ink through the ejection nozzles, an operation of driving the maintenance mechanism 50, an operation of detecting presence/absence of inks in the ink cartridges 100, and the like.

### Configuration of Ink Cartridge

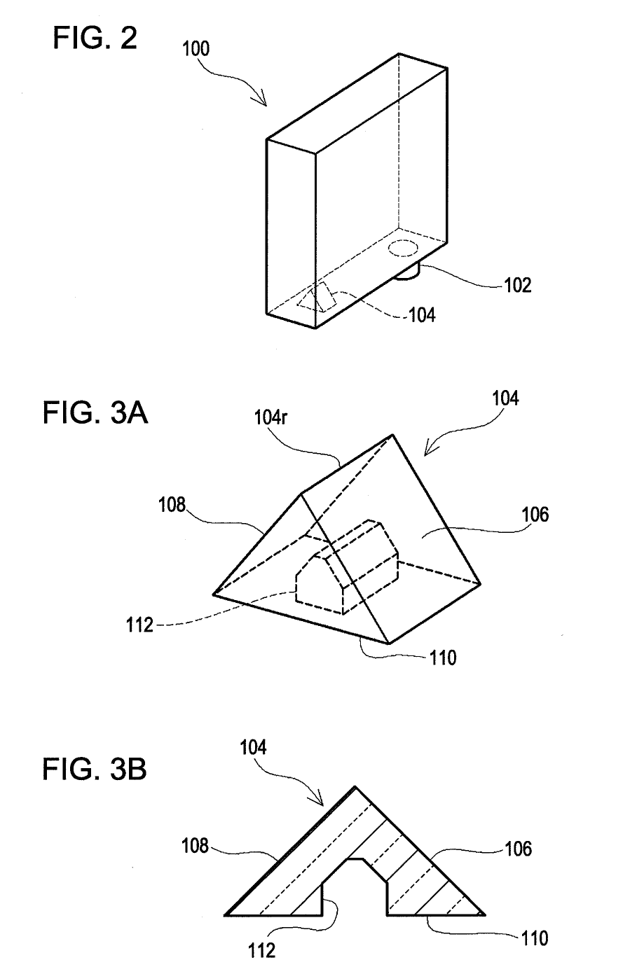

FIG. 2 is a perspective view illustrating a schematic configuration of the ink cartridge 100 according to the embodiment. As illustrated in FIG. 2, the ink cartridge 100 is a box which is formed by a hard resin material into a hexahedron shape. An inner portion of the box corresponds to a liquid accommodation chamber which accommodates ink.

An ink supply port 102 for supplying ink to the ejecting head 24 is provided on a bottom surface of the ink cartridge 100. A recess (not illustrated) for attaching the ink cartridge 100 from the upper side is provided on the carriage case 22 to which the ink cartridge 100 is attached. An ink intake needle (not illustrated) is erected toward the upper side on a bottom surface of the recess. If the ink cartridge 100 is attached to the recess of the carriage case 22, the ink intake needle is inserted into the ink supply port 102 so that ink in the ink cartridge 100 is taken into by the ink intake needle and is supplied to the ejecting head 24. It is to be noted that an air-intake hole (not illustrated) is provided on an upper surface of the ink cartridge 100 and the air is introduced thereto through the air-intake hole with consumption of ink in the ink cartridge 100. Therefore, an inner portion of the ink cartridge 100 is not made to be at a negative pressure.

Further, a prism 104 formed with a plastic material that transmits light is provided on a bottom portion in the ink cartridge 100 (liquid accommodation chamber). A bottom surface of the prism 104 constitutes a part of a bottom surface of the ink cartridge 100. An opening (not illustrated) is provided on a bottom surface of the carriage case 22 to which the ink cartridge 100 is attached at a position corresponding to the prism 104. When the ink cartridge 100 passes through a position above the sensor 200 with the movement of the carriage 20 (see, FIG. 1), light irradiated from the light emitting element of the sensor 200 is incident on the prism 104 from the bottom surface side.

FIGS. 3A and 3B are descriptive views illustrating a shape of the prism 104 provided in the ink cartridge 100 according to the embodiment. FIG. 3A illustrates an appearance shape of the prism 104. The prism 104 according to the embodiment is a so-called rectangular prism having a first reflection surface 106 and a second reflection surface 108 which are orthogonal to each other. The prism 104 is installed on the bottom portion of the ink cartridge 100 such that the first reflection surface 106 and the second reflection surface 108 make contact with ink in the ink cartridge 100. Further, a recess 112 called “relief” is provided on a bottom surface 110 of the prism 104.

FIG. 3B illustrates a cross section obtained by cutting the prism 104 along a plane orthogonal to the first reflection surface 106 and the second reflection surface 108. As illustrated in FIG. 3B, the prism 104 has a cross section of an isosceles right triangular shape that each of the first reflection surface 106 and the second reflection surface 108 is provided at 45 degrees with respect to the bottom surface 110. Further, the relief 112 having a cross section of a hexagonal shape such that two corner portions of a quadrangular shape are obliquely cut off is provided toward an inner portion of the prism 104 from the bottom surface 110 forming a hypotenuse of the isosceles right triangle. It is to be noted that the function and shape of the relief 112 will be described in detail later.

In the ink cartridge 100 according to the embodiment in which the prism 104 having the above configuration is provided on the bottom portion, presence/absence of ink therein is detected as follows.

### Ink Detection Method

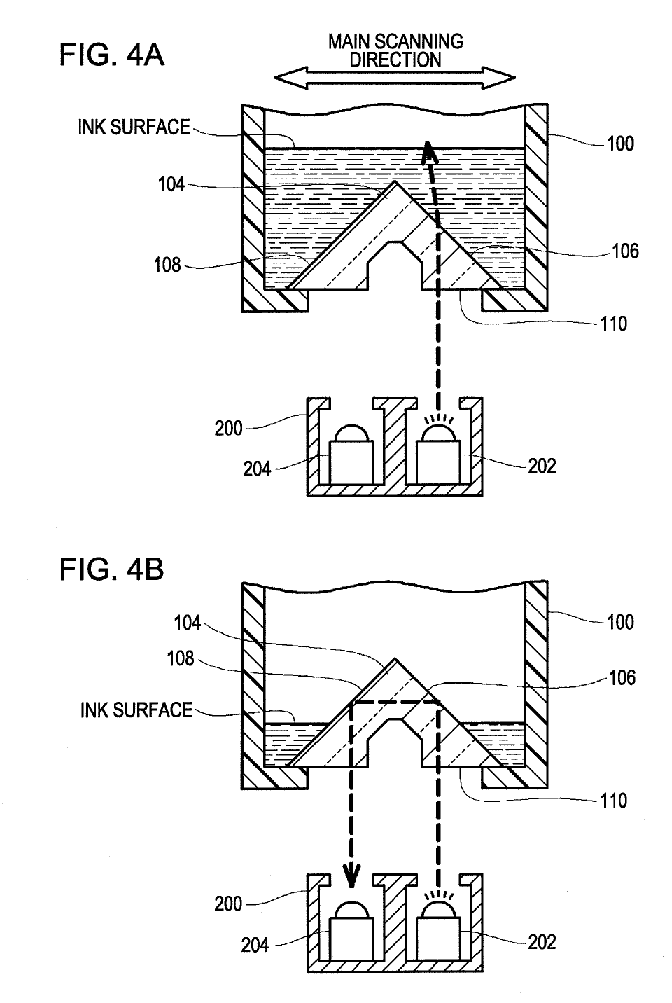

FIGS. 4A and 4B are descriptive views schematically illustrating a state where presence/absence of ink in the ink cartridge 100 is detected by using the prism 104. At first, as described above, the ink cartridge 100 is attached to the carriage 20 which reciprocates in the main scanning direction. As illustrated in FIGS. 4A and 4B, the first reflection surface 106 and the second reflection surface 108 are arranged in the main scanning direction on the prism 104 in the ink cartridge 100 in an attached state. An intersection line 104r (FIG. 3A) of the first reflection surface 106 and the second reflection surface 108 is orthogonal to the main scanning direction. Further, the sensor 200 is provided at a lower position with respect to the carriage 20 halfway on a path on which the carriage 20 moves in the main scanning direction. A light emitting element 202 which is formed by an infrared-emitting diode and a light receiving element 204 which is formed by a phototransistor are provided in the sensor 200 so as to be lined in the main scanning direction. The light emitting element 202 and the light receiving element 204 direct to the upper side in the vertical direction. Further, the light emitting element 202 and the light receiving element 204 are partitioned from each other by a member through which light does not transmit. Therefore, light from the light emitting element 202 does not reach the light receiving element 204 directly. When the ink cartridge 100 passes through a position above the sensor 200 with the movement of the carriage 20, light irradiated from the light emitting element 202 to the upper side in the vertical direction is incident from the bottom surface 110 of the prism 104.

FIGS. 4A and 4B illustrate a state where the ridge of the prism 104 in the ink cartridge 100 is located at a position above a center of the sensor 200 in the vertical direction with the movement of the carriage 20. In other words, FIGS. 4A and 4B illustrate a state where the intersection line 104r of the first reflection surface 106 and the second reflection surface 108 is located at a position above an intermediate position between the light emitting element 202 and the light receiving element 204. Hereinafter, a state where the prism 104 reaches the position while the carriage 20 being moved is referred to as an “origin”. At this time, if a liquid level of ink (ink surface) in the ink cartridge 100 is at the upper side with respect to the prism 104 as illustrated in FIG. 4A, the first reflection surface 106 and the second reflection surface 108 are in contact with (covered by) the ink. In this state, light (incident light) which has been irradiated from the light emitting element 202 toward the upper side in the vertical direction and incident on the prism 104 is not reflected even if the light hits the first reflection surface 106, and transmits through the ink in the ink cartridge 100 in a refraction manner as indicated by an arrow in a bold dashed line in FIG. 4A. Therefore, the light from the light emitting element 202 does not reach the light receiving element 204.

On the other hand, if ink in the ink cartridge 100 is consumed and the ink surface becomes lower with respect to the ridge of the prism 104 as illustrated in FIG. 4B, the air is in contact with the first reflection surface 106 and the second reflection surface 108 on a portion of the prism 104 which is exposed from the ink. Further, if the amount of ink in the ink cartridge 100 is reduced to be smaller than a predetermined amount and the incident light hits the portion of the first reflection surface 106, which is in contact with the air, the light is reflected by the first reflection surface 106 along the horizontal direction as indicated by an arrow in a bold dashed line in FIG. 4B. If the light reflected by the first reflection surface 106 hits the portion of the second reflection surface 108, which is in contact with the air, the light is reflected by the second reflection surface 108 toward the lower side in the vertical direction. The light reflected by the second reflection surface 108 in the above manner reaches the light receiving element 204 which is arranged in parallel with the light emitting element 202 with a predetermined space there between. It is to be noted that the space between the light emitting element 202 and the light receiving element 204 is set to such a space that the light irradiated from the light emitting element 202 is reflected by the first reflection surface 106 and the second reflection surface 108 so as to reach the light receiving element 204 in a state where the prism 104 is located at the origin. Further, in the specification, a light path on which the light irradiated from the light emitting element 202 is reflected by the first reflection surface 106 and the second reflection surface 108 so as to reach the light receiving element 204 is referred to as “reflected light path”.

Thus, if there is equal to or larger than the predetermined amount of ink in the ink cartridge 100, the light from the light emitting element 202 does not reach the light receiving element 204. On the other hand, if the amount of ink in the ink cartridge 100 is reduced to be smaller than the predetermined amount, the light from the light emitting element 202 reaches the light receiving element 204 through the reflected light path on which the light is reflected by the first reflection surface 106 and the second reflection surface 108 of the prism 104.

As described above, the overall operations of the ink jet printer 10 are controlled by the controller 60. When the ink cartridge 100 passes through a position above the sensor 200 with the movement of the carriage 20, light is irradiated from the light emitting element 202 of the sensor 200 onto the ink cartridge 100. Further, if the light receiving element 204 of the sensor 200 receives the light, a signal indicating the reception is input to the controller 60 from the sensor 200. If the light receiving element 204 does not receive light in a state where the prism 104 in the ink cartridge 100 is located at the origin, the controller 60 judges that equal to or larger than the predetermined amount of ink is left in the ink cartridge 100. On the other hand, if the light receiving element 204 receives light, the controller 60 judges that the amount of ink in the ink cartridge 100 is reduced to be smaller than the predetermined amount (ink-near-end) and performs displaying a message on a liquid crystal panel (not shown) to urge to exchange for a new ink cartridge 100. Note that as described above, in the ink jet printer 10 according to the embodiment, the ink cartridges 100 for respective ink types (cyan, magenta, yellow, and black) are attached to the carriage case 22 so as to be lined in the main scanning direction (see, FIG. 1). Presence/absence of ink is detected at the original position of the prism 104 for each of the ink cartridges 100 for respective colors while moving the carriage 20.

Note that the relief 112 as a recess formed inward from the bottom surface 110 is provided on the prism 104 as described above. Further, on the prism 104 mounted on the ink cartridge 100 according to the embodiment, the relief 112 is formed to have a cross section of a unique hexagonal shape as described above. With this, detection sensitivity for ink in the ink cartridge 100 can be improved. This configuration will be described in detail. However, preparatory to that, a reason why the relief 112 is provided on the prism 104 and the existing prism 104 having the relief 112 are simply described at first.

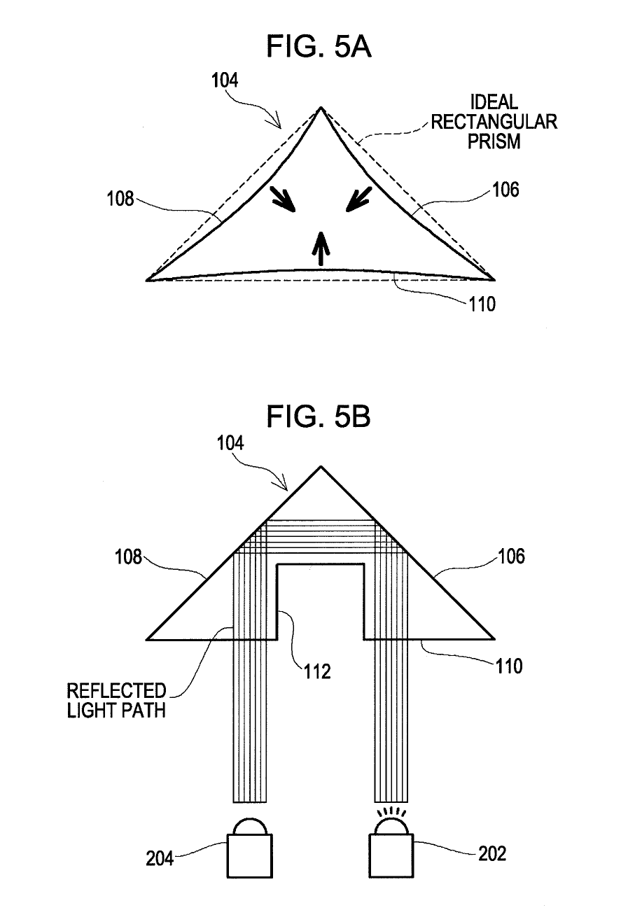

FIGS. 5A and 5B are descriptive views for explaining a reason why the relief 112 is provided on the prism 104 and illustrating the existing prism 104 having the relief 112. It is to be noted that FIGS. 5A and 5B illustrate a cross section obtained by cutting the prism 104 along a plane orthogonal to the first reflection surface 106 and the second reflection surface 108. As described above, the prism 104 in the ink cartridge 100 is formed with a plastic material that transmits light and is manufactured by injection molding by using a mold in a normal case. When the prism 104 is manufactured, so-called sink marks are generated due to contraction when the plastic material is solidified. The degree of the sink marks becomes larger on a portion having a larger thickness. Therefore, center portions with sink and surface deformation are generated on the surfaces (first reflection surface 106, second reflection surface 108, bottom surface 110) of the prism 104 that has no relief 112 as illustrated in FIG. 5A. If the first reflection surface 106 and the second reflection surface 108 of the prism 104 are warped, light from the light emitting element 202 is not reflected appropriately by the first reflection surface 106 and the second reflection surface 108 and is difficult to reach the light receiving element 204. Accordingly, detection sensitivity for ink in the ink cartridge 100 is lowered.

Then, as a measure for surpressing the sink marks from being generated, the relief 112 as a recess for reducing the thickness is provided on the bottom surface 110 of the prism 104. From a viewpoint of suppressing the sink marks from being generated, the relief 112 is desired to be as large as possible. However, since the reflected light path is formed in the prism 104 as illustrated in FIG. 5B if the light having a predetermined width is irradiated from the light emitting element 202 to the upper side in the vertical direction, the relief 112 of the prism 104 needs to be provided so as not to obstruct the reflected light path. Note that the reflected light path is a path on which the light irradiated from the light emitting element 202 is reflected by the first reflection surface 106 of the prism 104 along the horizontal direction, and is further reflected by the second reflection surface 108 toward the lower side in the vertical direction so as to reach the light receiving element 204. Therefore, the existing relief 112 of the prism 104 is normally formed to have a cross section of a quadrangular shape along the reflected light path as illustrated in FIG. 5B.

If such relief 112 is provided on the bottom surface 110 of the prism 104, the thickness of the prism 104 is reduced. Therefore, sink marks are suppressed from being generated on the prism 104 as a whole so that deformation of the first reflection surface 106 and that of the second reflection surface 108 are largely reduced. However, with the existing prism 104 having the relief 112, although the deformation of the first reflection surface 106 and that of the second reflection surface 108 are reduced, detection sensitivity for ink in the ink cartridge 100 is not improved, and is rather lowered in some case. This problem arises for the following reason.

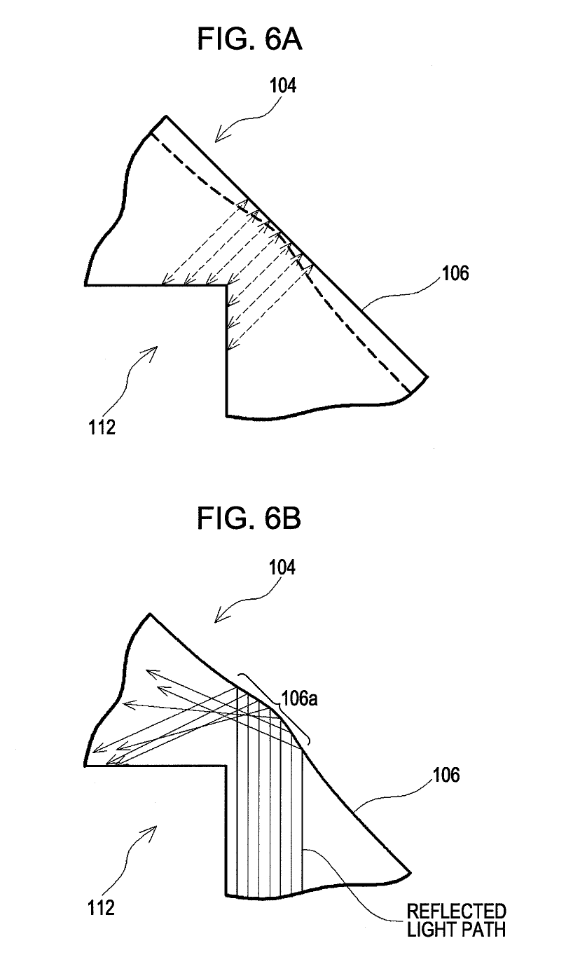

FIGS. 6A and 6B are descriptive views for explaining a reason why detection sensitivity for ink in the ink cartridge 100 is lowered with the existing prism 104 having the relief 112. In FIGS. 6A and 6B, a portion of the relief 112, which is opposed to the first reflection surface 106, on the existing prism 104 as illustrated in FIG. 5B is illustrated in an enlarged manner. At first, as illustrated in FIG. 6A, in the existing prism 104 on which the relief 112 having a cross section of a quadrangular shape is provided, a corner portion of the quadrangular shape is closer to the first reflection surface 106 and a thickness of the prism 104 is suddenly changed to be smaller on that portion. Therefore, the degree of the sink marks is largely changed around that portion. Accordingly, the actual first reflection surface 106 is not a smooth flat surface and strain is generated on the first reflection surface 106 depending on the degree of the sink marks as indicated by a dashed line in FIG. 6A.

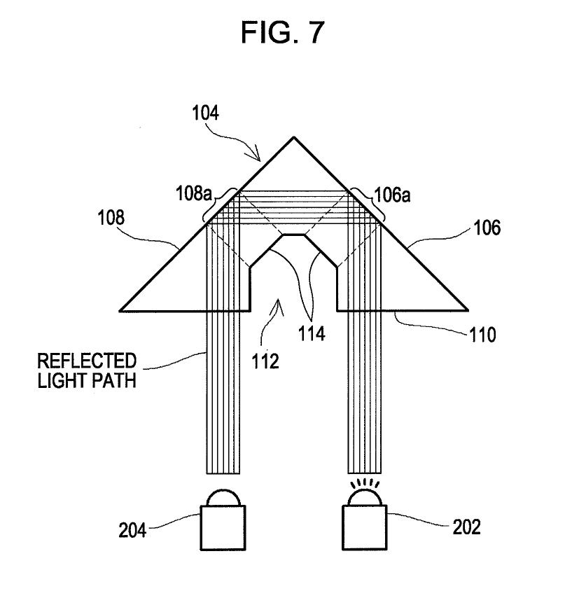

Further, the corner portion of the quadrangular relief 112 is opposed to a region (first reflection region 106a) on the first reflection surface 106, which intersects with the reflected light path. Therefore, such strain on the first reflection surface 106 appears on the first reflection region 106a as illustrated in FIG. 6B. If the light having a predetermined width, which has been irradiated from the light emitting element 202, hits the first reflection region 106a strained in this manner, the light is reflected by the first reflection region 106a at various angles and the reflection direction cannot be made uniform. As a result, an amount of light which reaches the light receiving element 204 is decreased, resulting in lowering the detection sensitivity for ink in the ink cartridge 100. Note that in the above description, the first reflection region 106a on the first reflection surface 106 has been described as an example. However, strain is also generated on a region (second reflection region 108a, FIG. 7) on the second reflection surface 108, which intersects with the reflected light path, resulting in lowering the detection sensitivity for ink in the ink cartridge 100 in the same manner.

Considering the above, on the prism 104 mounted on the ink cartridge 100 according to the embodiment, the relief 112 is formed into the following shape so as to improve the detection sensitivity for ink in the ink cartridge 100.

FIG. 7 is a descriptive view illustrating a shape of the relief 112 formed on the prism 104 of the ink cartridge 100 according to the embodiment. FIG. 7 illustrates a cross section obtained by cutting the prism 104 along a plane orthogonal to the first reflection surface 106 and the second reflection surface 108. As illustrated in FIG. 7, on the prism 104 mounted on the ink cartridge 100 according to the embodiment, the relief 112 is formed to have not a cross section of a quadrangular shape which is formed so as to avoid the above-mentioned reflected light path in the prism 104 but a cross section of the following shape. That is, the relief 112 is formed to have a cross section of a hexagonal shape such that corner portions of the quadrangular shape, which are opposed to the first reflection region 106a and the second reflection region 108a, are cut off so as to be parallel with both the reflection regions respectively. Therefore, the portions of the relief 112, which are opposed to the first reflection region 106a and the second reflection region 108, are not corners but planes. Hereinafter, the planes of the relief 112, which are opposed to the first reflection region 106a and the second reflection region 108a, are referred to as “opposing surfaces 114”. In addition, the opposing surface 114 opposed to the first reflection region 106a is referred to as “first opposing surface 114a” and the opposing surface 114 opposed to the second reflection region 108a is referred to as “second opposing surface 114b” in some case.

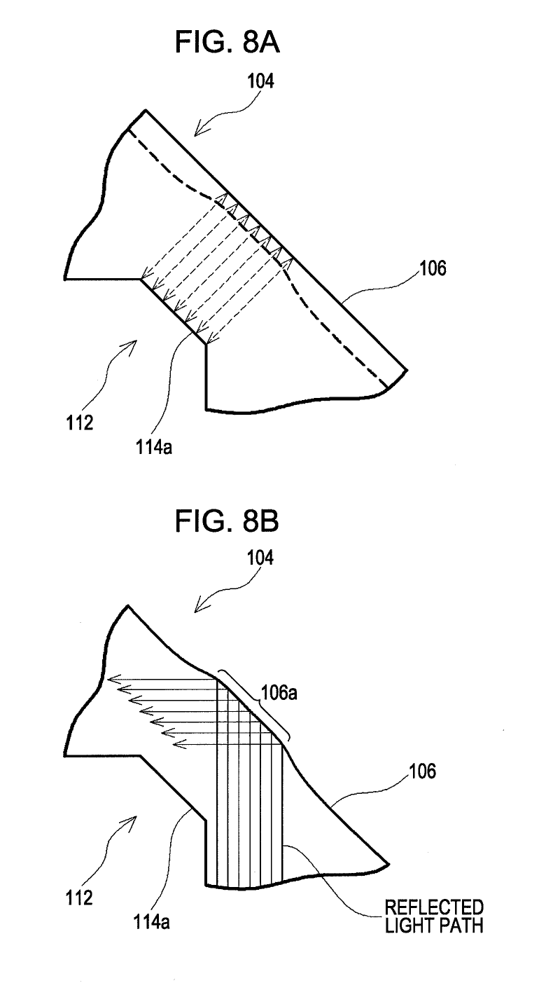

FIGS. 8A and 8B are descriptive views for explaining a reason why the detection sensitivity for ink in the ink cartridge 100 is improved by providing the opposing surfaces 114 on the relief 112. In FIGS. 8A and 8B, a periphery of the first opposing surface 114a provided on the relief 112 on the prism 104 according to the embodiment as illustrated in FIG. 7 is shown in an enlarged manner. At first, as illustrated in FIG. 8A, the first opposing surface 114a is provided on the relief 112 so that the thickness of the prism 104 is avoided from largely changing and the thickness thereof is kept to be constant in a range where the first opposing surface 114a is provided. Therefore, the degree of sink marks in the range is made uniform. Accordingly, even if sink marks are generated on the first reflection surface 106 of the prism 104 as indicated by a dashed line in FIG. 8A, strain on the first reflection surface 106 can be suppressed in the range where the first opposing surface 114a is provided.

Then, if the first opposing surface 114a is provided to have a width equivalent to the first reflection region 106a on the first reflection surface 106, which intersects with the reflected light path, strain at least on the first reflection region 106a can be suppressed. Therefore, as illustrated in FIG. 8B, if light having a predetermined width, which has been irradiated from the light emitting element 202, hits the first reflection region 106a, the first reflection region 106a reflects the light at a predetermined angle so as to introduce the light in a constant direction. It is to be noted that on the prism 104 according to the embodiment, if the second opposing surface 114b opposed to the second reflection region 108a is provided to have a width equivalent to the second reflection region 108a, strain on the second reflection region 108a can be also suppressed in the same manner.

As described above, on the prism 104 mounted on the ink cartridge 100 according to the embodiment, the relief 112 is not formed simply into a shape (quadrangular) so as not to obstruct the reflected light path in the prism 104. Alternatively, the relief 112 is formed such that planes (opposing surfaces 114) having widths equivalent to the reflection regions are provided on portions opposed to the first reflection region 106a and the second reflection region 108a. With this, the thickness of the prism 104 is avoided from largely changing on the first reflection region 106a and the second reflection region 108a, thereby suppressing strain from being generated thereon. Therefore, the light having a predetermined width, which has been irradiated from the light emitting element 202, can be reflected by the first reflection region 106a and the second reflection region 108a in the appropriate directions so as to reach the light receiving element 204. This makes it possible to improve the detection sensitivity for ink in the ink cartridge 100.

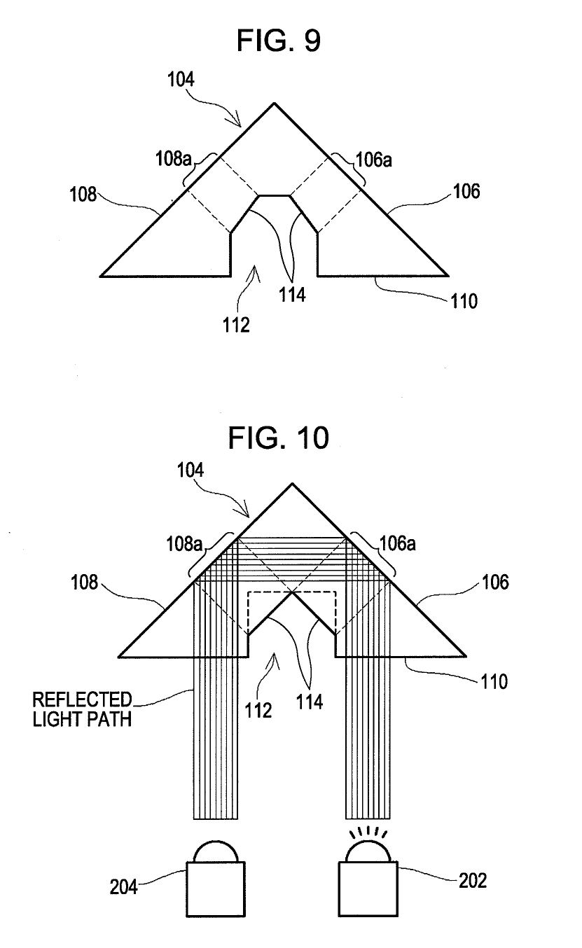

Even if the opposing surfaces 114 are not necessarily parallel with the reflection regions (first reflection region 106a, second reflection region 108a) as illustrated in FIG. 9, the thickness of the prism 104 can be avoided from largely changing. Therefore, even in this case, an effect that the reflection regions are suppressed from being strained can be expected. Note that if the opposing surfaces 114 are parallel with the reflection regions as in the embodiment, the thickness of the prism 104 is made constant so that the reflection regions are suppressed from being strained further effectively.

Further, the relief 112 needs to be set to have a size so as not to obstruct the reflected light path even if manufacturing error occurs or positioning error for the origin of the prism 104 occurs. On the other hand, unless the relief 112 is ensured to have a certain size, an effect that sink marks (deformation of the first reflection surface 106 and the second reflection surface 108, see FIG. 5A) are suppressed from being generated on the prism 104 as a whole cannot be expected. From this viewpoint, it is preferable that the size of the relief 112 be set as follows based on a size of a quadrangular shape (see, FIG. 7) surrounded by the bottom surface 110 of the prism 104 and the reflected light path. That is, it is preferable that a height of the relief 112 (height from the bottom surface 110) be set to be equal to or higher than half of the height of the quadrangular shape. Further, it is preferable that a width of the relief 112 (width in a direction that the light emitting element 202 and the light receiving element 204 are lined) be set to be equal to or larger than half of the width of the quadrangular shape.

### Variations

There are several variations on the ink cartridge 100 according to the embodiment as described above. Hereinafter, these variations are described. It is to be noted that in the description of the variations, constituent components which are the same as those in the above embodiment are denoted with the reference numerals which are the same as those in the above embodiment and detail description thereof is not repeated.

### First Variation

In the above embodiment, the cross section of the relief 112 obtained by cutting the prism 104 along a plane orthogonal to the first reflection surface 106 and the second reflection surface 108 is formed into a hexagonal shape. However, the cross section of the relief 112 is not limited to the hexagonal shape as long as planes (opposing surfaces 114) opposed to the first reflection region 106a and the second reflection region 108a are provided and it may be a pentagonal shape.

FIG. 10 is a cross-sectional view illustrating the prism 104 having the relief 112 of which cross-sectional shape is pentagonal according to the first variation. The prism 104 according to the first variation as illustrated in FIG. 10 is set to have a width of a reflected light path (width of light irradiated from the light emitting element 202) which is larger than that in the embodiment as illustrated in FIG. 7 and width of the first reflection region 106a and that of the second reflection region 108a are larger in response thereto. Further, in the example as illustrated in FIG. 10, if the opposing surfaces 114 of the relief 112 are provided to have widths equivalent to the first reflection region 106a and the second reflection region 108a, the first opposing surface 114a and the second opposing surface 114b intersect with each other so that the cross-sectional shape of the relief 112 becomes pentagonal.

Thus, in the prism 104 having the relief 112 of which cross-sectional shape is pentagonal according to the first variation, the opposing surfaces 114 as planes having widths equivalent to the reflection regions are also formed on portions of the relief 112, which are opposed to the first reflection region 106a and the second reflection region 108a, as in the above embodiment. Therefore, a thickness of the prism 104 is avoided from largely changing on the first reflection region 106a and the second reflection region 108a, thereby suppressing strain from being generated thereon. As a result, light having a predetermined width, which has been irradiated from the light emitting element 202, can be reflected by the first reflection region 106a and the second reflection region 108a in the appropriate directions so as to reach the light receiving element 204. This makes it possible to improve the detection sensitivity for ink in the ink cartridge 100.

### Second Variation

Further, in the prism 104 according to the first variation as described above, the cross-sectional shape of the relief 112 may be triangular for reducing the entire prism 104 in size.

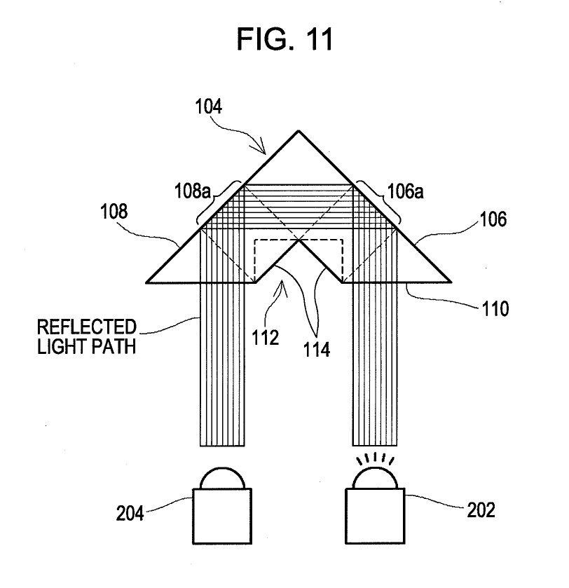

FIG. 11 is a cross-sectional view illustrating the prism 104 having the relief 112 of which cross-sectional shape is triangular according to the second variation. In the prism 104 according to the second variation as illustrated in FIG. 11, a width of a reflected light path (width of light irradiated from the light emitting element 202) and a space between the light emitting element 202 and the light receiving element 204 are set to be the same as those in the first variation as illustrated in FIG. 10. However, a size of the prism 104 itself is set to be smaller than that of the prism 104 according to the first variation. In response thereto, a height of the relief 112 is made lower so as not to obstruct the reflected light path. Further, in the example as illustrated in FIG. 11, if the opposing surfaces 114 of the relief 112 are provided to have widths equivalent to the first reflection region 106a and the second reflection region 108a, the first opposing surface 114a and the second opposing surface 114b intersect with each other so that the cross-sectional shape of the relief 112 becomes triangular.

Thus, in the prism 104 having the relief 112 of which cross-sectional shape is triangular according to the second variation, the opposing surfaces 114 which are opposed to the first reflection region 106a and the second reflection region 108a are provided on the relief 112 as in the above embodiment and the first variation. Therefore, strain on the first reflection region 106a and the second reflection region 108a can be suppressed from being generated. As a result, the prism 104 itself can be reduced in size without lowering the detection sensitivity for ink in the ink cartridge 100.

Hereinbefore, various embodiments have been described. However, the invention is not limited to any of the above embodiments and can be executed in various modes in a range without departing from the scope of the invention.

What is claimed is:

1. A liquid container configured to be detachably attached to a liquid ejecting apparatus that includes an optical sensor, the optical sensor including a light emitting element and a light receiving element, the liquid container comprising:
a liquid chamber that accommodates a liquid to be ejected from the liquid ejecting apparatus; and
a prism disposed on a bottom portion of the liquid chamber, the prism including a first reflection surface having a first reflection region by which light incident on the prism from the light emitting element is reflected when the liquid does not make contact with the first reflection region, and a relief that includes a first relief surface opposed to the first reflection region, the thickness of the prism between the first reflection region and the first relief surface being substantially constant.

2. The liquid container according to claim 1, wherein the prism comprises a molded resin.

3. The liquid container according to claim 1, wherein the relief is formed into a shape so as not to overlap with any of a light path between the light emitting element and the first reflection region, and a light path between the first reflection region and the light receiving element.

4. The liquid container according to claim 3, wherein the first relief surface is a plane offset from the first reflection region.

5. The liquid container according to claim 4, wherein the first relief surface is a plane parallel to the first reflection region.

6. The liquid container according to claim 1, the prism further comprising a second reflection surface having a second reflection region by which light reflected by the first reflection region is reflected toward the light receiving element when the liquid does not make contact with the second reflection region, the relief further including a second relief surface opposed to the second reflection region, the thickness of the prism between the second reflection region and the second relief surface being substantially constant.

7. The liquid container according to claim 6, wherein the prism comprises a molded resin.

8. The liquid container according to claim 6, wherein the relief is formed into a shape so as not to overlap with any of a light path between the light emitting element and the first reflection region, a light path between the first reflection region and the second reflection region, and a light path between the second reflection region and the light receiving element.

9. The liquid container according to claim 6, wherein the first relief surface is a plane offset from the first reflection region and the second relief surface is a plane offset from the second reflection region.

10. The liquid container according to claim 9, wherein the first relief surface is a plane parallel to the first reflection region and the second relief surface is a plane parallel to the second reflection region.

11. A liquid ejecting apparatus comprising the liquid container according to claim 1.

12. A liquid ejecting apparatus comprising the liquid container according to claim 2.

13. A liquid ejecting apparatus comprising the liquid container according to claim 3.

14. A liquid ejecting apparatus comprising the liquid container according to claim 4.

15. A liquid ejecting apparatus comprising the liquid container according to claim 5.

16. A liquid ejecting apparatus comprising the liquid container according to claim 6.

17. A liquid ejecting apparatus comprising the liquid container according to claim 7.

18. A liquid ejecting apparatus comprising the liquid container according to claim 8.

19. A liquid ejecting apparatus comprising the liquid container according to claim 9.

20. A liquid ejecting apparatus comprising the liquid container according to claim 10.
